(19) United States
(12) Patent Application Publication
(10) Pub. No.: US 2025/0136037 A1
(43) Pub. Date: May 1, 2025

(54) Belt Buckle Power Actuator For A Vehicle Seat

(71) Applicant: Fisher & Company, Incorporated, St. Clair Shores, MI (US)

(72) Inventors: Mircea NAPAU, Sterling Heights, MI (US); Sapan Mahendra Poptani, Northville, MI (US); Ryan Martin, Macomb, MI (US); Lailai Zhang, St. Clair Shores, MI (US)

(73) Assignee: Fisher & Company, Incorporated, St. Clair Shores, MI (US)

(21) Appl. No.: 18/912,720

(22) Filed: Oct. 11, 2024

Related U.S. Application Data
(60) Provisional application No. 63/545,999, filed on Oct. 27, 2023.

(51) Int. Cl. B60R 22/20; B60R 22/18; B60R 22/26

(52) U.S. Cl. CPC B60R 22/201; B60R 22/18; B60R 22/26; B60R 2022/1806; B60R 2022/207

(57) ABSTRACT

A belt buckle power actuator for a vehicle seat assembly may include a seat belt buckle arm pivotally mounted adjacent to a vehicle seat. The actuator include a motor having a drive shaft drivingly connected to a drive gear. A driven gear is meshingly driven by the drive gear and is drivingly connected to a lead screw. A nut is threadedly engaged with the lead screw and drivingly connected to the seat belt buckle arm.

### CROSS-REFERENCE TO RELATED APPLICATIONS

This application claims the benefit of U.S. Provisional Application No. 63/545,999, filed on Oct. 27, 2023. The entire disclosure of the above application is incorporated herein by reference.

### FIELD

The present disclosure relates to a belt buckle power actuator for a vehicle seat.

### BACKGROUND

This section provides background information related to the present disclosure and is not necessarily prior art.

The angular position of a vehicle seat belt can impact the effectiveness of the seat belt system and the comfort of the passenger. The ability to adjust a position, height and orientation of a vehicle seat can impact the proper orientation of the seat belt. Accordingly, it is desirable to provide a belt buckle power actuator for a vehicle seat.

### SUMMARY

This section provides a general summary of the disclosure and is not a comprehensive disclosure of its full scope or all of its features.

A belt buckle power actuator includes a seat belt buckle arm pivotally mounted adjacent to a vehicle seat. The actuator includes a motor having a drive shaft drivingly connected to a drive gear. A driven gear is driven by the drive gear and is drivingly connected to a lead screw. A nut is threadedly engaged with the lead screw and drivingly connected to the seat belt buckle arm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is an exploded perspective view of a belt buckle power actuator for a vehicle seat;

FIG. 2 is a perspective view of the belt buckle power actuator mounted to a slide base of a vehicle seat assembly;

FIG. 3 is a side plan view of the belt buckle power actuator;

FIG. 4 is a top perspective view of the belt buckle power actuator connected to the pivot shaft of the seat belt buckle;

FIG. 5 is a rear perspective view of the pivotal mounting of the belt buckle power actuator to the slide base of a seat assembly;

FIG. 6 is a side plan view of the belt buckle power actuator according to the principles of the present disclosure;

FIG. 7 is a cross sectional view taken along line B-B of FIG. 6 showing the turn shaft of the pivot bracket;

FIG. 8 is a cross-sectional view taken along line C-C of FIG. 7 showing the splined connection of the belt buckle to the turn shaft;

FIG. 9 is a cross-sectional view taken along the line E-E of FIG. 6 showing the pivotal connection between the mount bracket and the pivot assembly by the pivot pin;

FIG. 10 is a cross-sectional view taken along line F-F of FIG. 6 showing the connection of the nut to the pivot bracket.

Corresponding reference numerals indicate corresponding parts throughout the several views of the drawings.

### DETAILED DESCRIPTION

Example embodiments will now be described more fully with reference to the accompanying drawings.

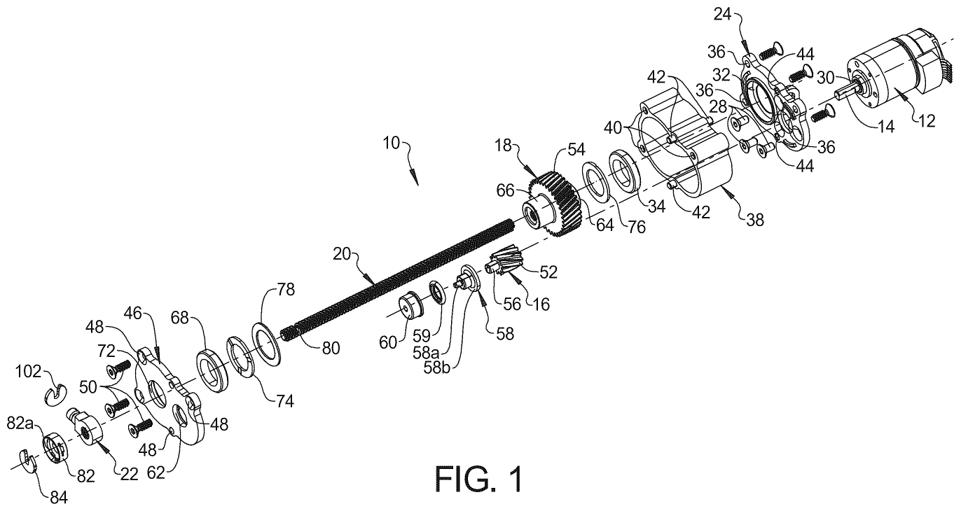

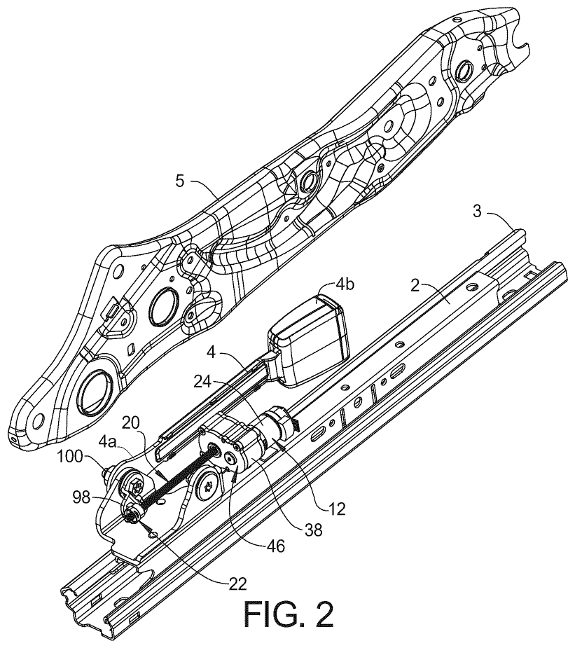

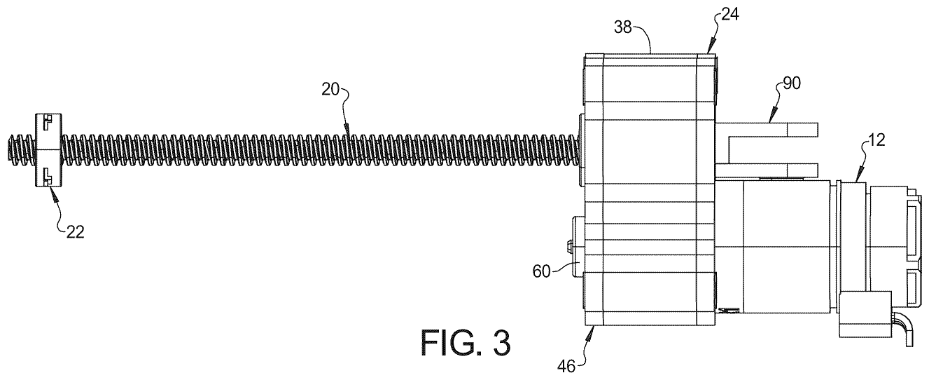

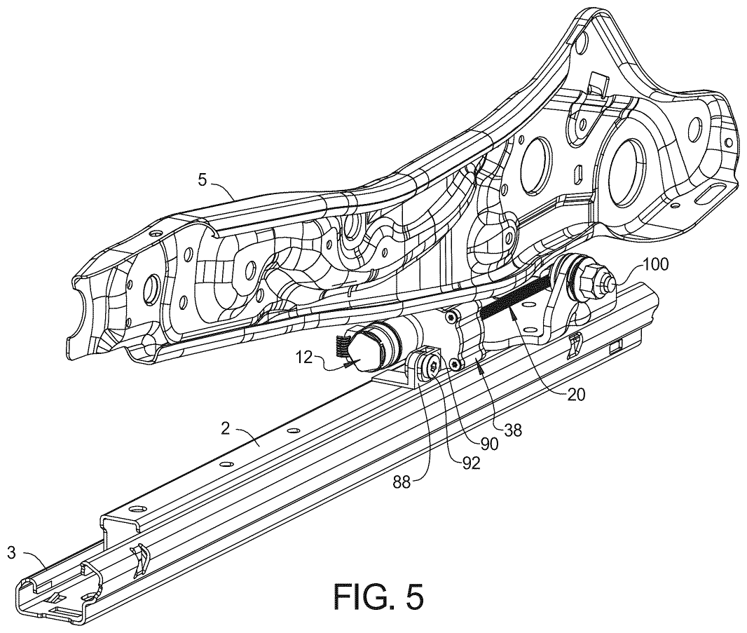

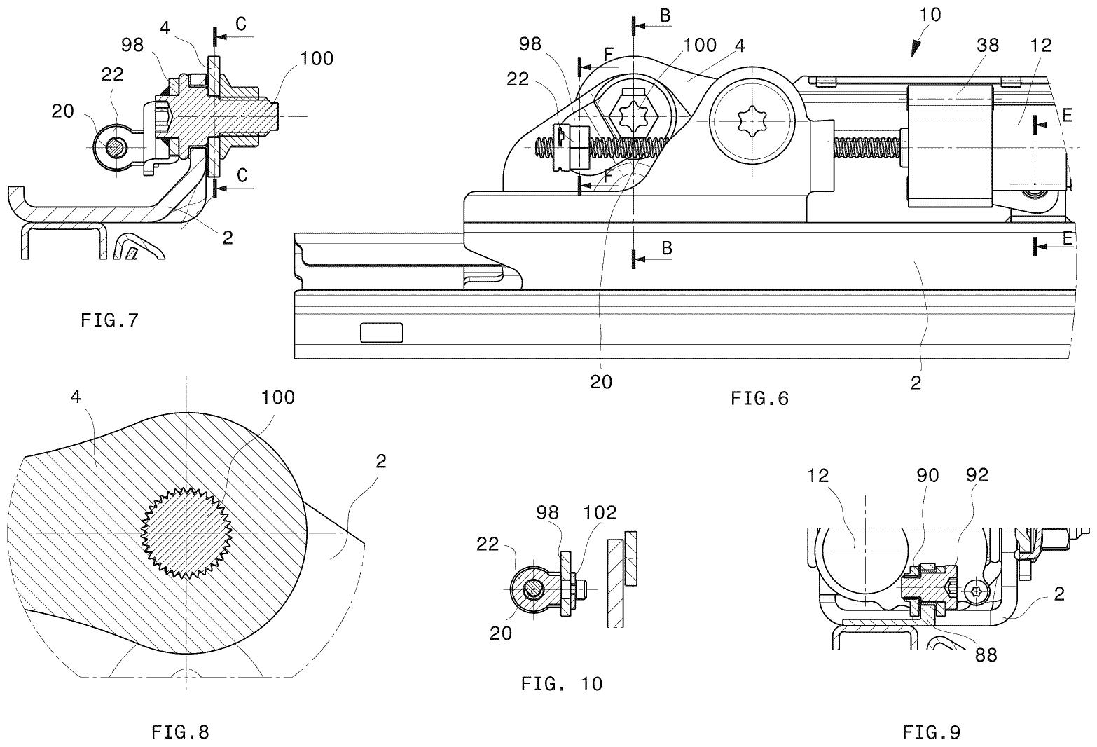

With reference to FIGS. 1-3, a belt buckle power actuator 10 according to the principles of the present disclosure will now be described. As shown in FIG. 2, the belt buckle power actuator 10 can be mounted to a slide base 2 of a vehicle seat assembly and connected to a first end 4a of a pivotally mounted seat belt buckle arm 4. The slide base 2 may be partially received in a track 3 and may be selectively slidable along a length of the track 3. A second end 4b of the seat belt buckle arm 4 may include a buckle that receives a latch plate (not shown) on a shoulder and lap belt webbing (not shown), for example. The belt buckle power actuator 10 can be mounted such that it is positioned adjacent to a seat frame 5 (partially shown in FIGS. 2 and 5) of the vehicle seat assembly.

With reference to FIG. 1, the belt buckle power actuator 10 includes a motor 12 having a drive shaft 14. A helical drive gear 16 is drivingly connected to the drive shaft 14 and in meshing engagement with a helical driven gear 18. A lead screw 20 is in driving engagement with the helical driven gear 18. A nut 22 is threadedly engaged with the lead screw 20.

The drive shaft 14 of the motor 12 can have a polygonal cross-section, one or more flats, a splined surface, a keyway or similar structure for connection with the helical drive gear 16. A motor cover 24 includes a plurality of mounting apertures for receiving attachment screws 28 for mounting the motor cover 24 to a face of the motor 12. The motor cover 24 includes an aperture 30 through which the drive shaft 14 extends. The motor cover 24 further includes a first recess 32 receiving a first bearing bushing 34 therein. The motor cover 24 further includes apertures 36 to which a first end of a gearbox housing 38 is mounted. The gearbox housing 38 includes corresponding mounting apertures 40 that extend therethrough and a plurality of alignment pins 42 extend from opposite ends of the gearbox housing 38. During assembly, the alignment pins 42 on one end of the gearbox housing 38 are inserted into alignment apertures 44 on the motor cover 24 and mounting screws 45 are inserted through the apertures 36 into the gearbox housing 38 mounting apertures 40.

A front cover 46 is connected to a second end of the gearbox housing 38. The front cover 46 includes a plurality of mounting apertures 48 that align with the mounting apertures 40 of the gearbox housing 38 and the threaded apertures 36 of the motor cover 24 for receiving attachment screws 50 that secure the front cover 46 to the gearbox housing 38.

The helical drive gear 16 has helical teeth 52 that are in meshing engagement with helical teeth 54 of the helical driven gear 18. A first end of the helical drive gear 16 includes an aperture with a polygonal cross-section, one or more flats, a splined surface, a keyway or similar structure for connection with the drive shaft 14. A second end of the drive gear 16 can include a shaft portion 56 received in a second bearing bushing assembly 58, 60 supported in an aperture 62 in the front cover 46. The second bearing bushing assembly 58, 60 includes a motor shaft bushing 58 received in a cup-shaped bushing 60 that is received in the aperture 62 in the front cover 46. The motor shaft bushing 58 includes a hollow cylindrical body 58a that receives the shaft portion 56 of the drive gear 16. The motor shaft bushing 58 includes a flange 58b extending from the hollow cylindrical body 58a. An O-ring 59 is provided between the flange 58b of the motor shaft bushing 58 and the bushing 60. The O-ring 59 behaves like a spring to provide an axial load against the drive pinion 16 to inhibit axial movement of the drive pinion 16.

The driven gear 18 includes a first shaft portion 64 extending from a first end and received in the first bearing bushing 34 and a second shaft portion 66 extending from a second end received in a third bearing bushing 68 supported within a second recess 70 in the front cover 46. The lead screw 20 is drivingly connected to the driven gear 18 and extends through an aperture 72 in the front cover 46. The lead screw 20 may be received in the second shaft portion 66 of the drive gear 18.

A pair of contact washers 74, 76 are disposed against the first bearing 34 and the third bearing bushing 68, respectively. The pair of contact washers 74, 76 can each include lubrication grooves on a face that engages the first and third bearing bushings 34, 68. A wavy spring 78 is provided between the contact washer 74 and the drive gear 18 and provides an axial load against the drive gear to inhibit axial movement of the drive gear 18.

A distal end of the lead screw 20 includes an annular groove 80 and a thrust ring 82 is mounted to the distal end of the lead screw by a stop ring 84 that is inserted into a slot 82a in the thrust ring 82 and engages the annular groove 80 to secure the thrust ring 82 to the lead screw 20.

With reference to FIGS. 5 and 9 (the seat belt buckle 4 has been removed in FIG. 5 for illustrative purposes), the gearbox housing 38 and motor 12 are shown pivotally mounted to the seat slide base 2 by a mount bracket 88 and pivot bracket 90. A pivot pin 92 pivotally supports the mount bracket 88 to the pivot bracket 90 for pivotally supporting the gearbox housing 38 and motor 12.

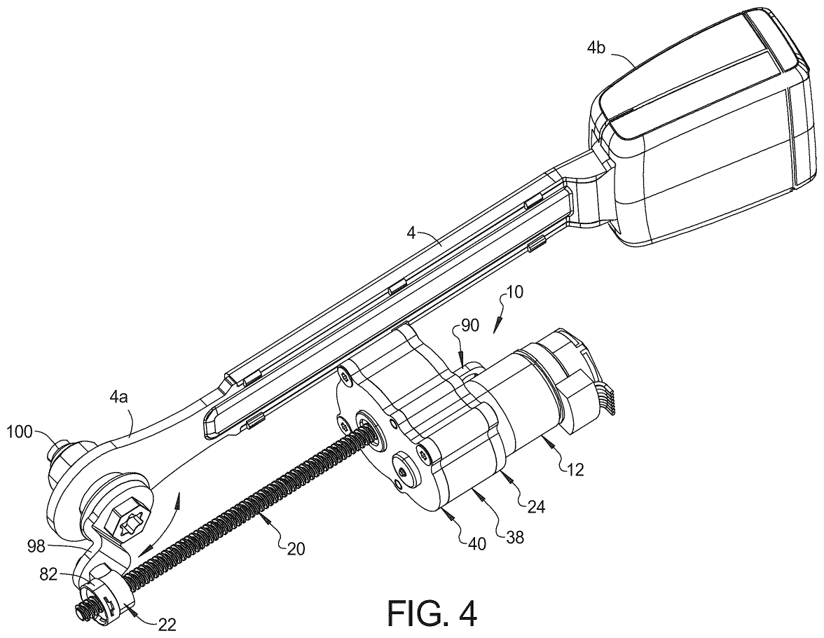

With reference to FIGS. 4, 7, 8 and 10, the nut 22 of the belt buckle power actuator 10 is connected to a pivot bracket 98 that is connected by a turn shaft 100 to the seat belt buckle arm 4. The nut 22 is connected to the pivot bracket by a C-clip 102, shown in FIGS. 1 and 10.

With reference to FIG. 2, the belt buckle power actuator 10 is designed to drive the seat belt buckle arm 4 over a 120 degree pivot range over an approximately 4 second duration. The seat belt buckle arm 4 is connected to the turn shaft 100 by a splined or other connection, as shown in FIG. 8. As the nut 22 traverses along the lead screw 20, the connecting between the nut 22 and the distal end of the pivot bracket 98 rotates along an arc. The pivotal mounting of the gearbox 38 and motor 12 about the pivot pin 92 allows the leadscrew to rotate up and down to facilitate the movement of the nut 22 along the arc. The adjustment of the seat belt buckle arm 4 can provide for improved passenger comfort.

In operation, the motor 12 drives the drive shaft 14 that drives the drive gear 16 which in turn drives the driven gear 18 and the lead screw 20. As the lead screw rotates, the nut 22 traverses along the leadscrew 20 in a fore and aft direction based upon rotational direction of the motor 12. The movement of the nut 22 along the lead screw 20 causes pivoting movement of pivot bracket 98 and the seat belt buckle 4 about the turn shaft 100. As the pivot bracket 98 is rotated, the nut 22 follows an arcuate path causing the motor 12 and gearbox housing to pivot about the pivot pin 92.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A belt buckle power actuator for a vehicle seat assembly, the belt buckle power actuator comprising:
a seat belt buckle arm pivotally mounted adjacent to a vehicle seat frame;
a motor having a drive shaft;
a drive gear drivingly connected to the drive shaft;
a driven gear meshingly driven by the drive gear;
a lead screw drivingly connected to the driven gear and is received in a portion of the driven gear; and
a nut threadedly engaged with the lead screw and drivingly connected to the seat belt buckle arm.

2. The belt buckle power actuator of claim 1, wherein the motor is pivotally mounted to a movable base of the vehicle seat assembly.

3. The belt buckle power actuator of claim 2, wherein the movable base is slidably engaged with a track.

4. The belt buckle power actuator of claim 1, wherein the nut is connected to the seat belt buckle arm by a pivot bracket rotatably fixed to the seat belt buckle arm.

5. The belt buckle power actuator of claim 1, wherein the drive gear is a helical gear.

6. The belt buckle power actuator of claim 5, wherein the driven gear is a helical gear.

7. The belt buckle power actuator of claim 1, wherein the driven gear includes a first shaft portion that extends away from the lead screw and is received in a bearing bushing.

8. The belt buckle power actuator of claim 7, wherein the portion of the driven gear is a second shaft portion that extends from the driven gear in a direction opposite the first shaft portion.

9. The belt buckle power actuator of claim 8, wherein the second shaft portion is received in another bearing bushing.

10. The belt buckle power actuator of claim 1, further comprising a gearbox housing, a motor cover, and a front cover, wherein the drive gear and the driven gear are disposed within the gearbox housing between the motor cover and the front cover, wherein the motor cover is mounted to the gearbox housing, wherein the motor is attached to the motor cover, and wherein the front cover is mounted to the gearbox housing.

11. A belt buckle power actuator for a vehicle seat assembly, the belt buckle power actuator comprising:
a seat belt buckle arm pivotally mounted adjacent to a vehicle seat frame;
a motor having a drive shaft;
a motor cover mounted to a face of the motor, the motor cover having an aperture through which the drive shaft extends, the motor cover further including a first recess receiving a first bearing bushing therein;
a gear box housing having a first end connected to the motor cover;
a front cover connected to a second end of the gear box;
a drive gear drivingly connected to the drive shaft and including a shaft portion received in a second bearing bushing supported by the front cover;
a driven gear meshingly driven by the drive gear, the driven gear including a first shaft portion received in the first bearing bushing and a second shaft portion received in a third bearing bushing supported within a second recess in the front cover;
a lead screw drivingly connected to the driven gear and extending through an aperture in the front cover; and
a nut threadedly engaged with the lead screw and drivingly connected to the seat belt buckle arm.

12. The belt buckle power actuator according to claim 11, wherein the motor is pivotally mounted to a movable base of the vehicle seat assembly.

13. The belt buckle power actuator of claim 12, wherein the movable base is slidably engaged with a track.

14. The belt buckle power actuator according to claim 11, wherein the nut is connected to the seat belt buckle arm by a pivot bracket rotatably fixed to the seat belt buckle arm.

15. The belt buckle power actuator of claim 14, wherein the lead screw is received in the second shaft portion.

16. The belt buckle power actuator of claim 15, wherein the second shaft portion that extends from the driven gear in a direction opposite the first shaft portion.

17. The belt buckle power actuator of claim 11, wherein the drive gear is a helical gear.

18. The belt buckle power actuator of claim 17, wherein the driven gear is a helical gear.
